(19) United States
(12) Patent Application Publication
(10) Pub. No.: US 2025/0035178 A1
(43) Pub. Date: Jan. 30, 2025

(54) DRUM BRAKE

(71) Applicant: HL MANDO CORPORATION, Gyeonggi-do (KR)

(72) Inventor: Pyeongkook SON, Gyeonggi-do (KR)

(21) Appl. No.: 18/393,155

(22) Filed: Dec. 21, 2023

(30) Foreign Application Priority Data
Jul. 25, 2023 (KR) 10-2023-0096627

(51) Int. Cl. F16D 65/22; F16D 51/22

(52) U.S. Cl. CPC F16D 65/22; F16D 51/22; F16D 2121/24; F16D 2125/30; F16D 2125/50

(57) ABSTRACT

A drum brake includes a motor configured to provide rotational driving force, a pair of pressurizing units configured to press a brake shoe into an inner circumferential surface of a drum, and a power transmission unit configured to transmit rotational driving force of the motor to the pressurizing units, wherein the power transmission unit includes a shaft rotating with rotational driving force of the motor, a cam rotating in connection with the shaft, and a pair of rollers arranged on opposite sides of the cam for a translational movement with rotation of the cam and fixed respectively to the pair of pressurizing units, and wherein the shaft and the cam are connected by a universal joint such that a rotational axis of the shaft and a rotational axis of the cam form a certain angle.

### CROSS-REFERENCE TO RELATED APPLICATION

This application claims the benefit of and priority to Korean Patent Application No. 10-2023-0096627, filed on Jul. 25, 2023 in the Korean Intellectual Property Office, the disclosure of which is incorporated herein by reference in its entirety.

### BACKGROUND

### 1. Field

Some embodiments of the present disclosure relate to a drum brake, and more particularly to a drum brake that achieves miniaturization of the drum brake and improves braking stability.

### 2. Description of the Related Art

Vehicles are essentially equipped with a brake system to perform braking, and various types of brake systems are being proposed for the safety of drivers and passengers.

Drum brakes are one of these brake systems, utilizing the frictional force from the contact between the drum and brake shoe as braking power.

Traditional drum brakes generated a vehicle's braking force by mechanically supplying hydraulic pressure to the wheel cylinder when the driver pressed the brake pedal through a connected booster.

However, today's next-generation brake systems generate a vehicle's braking force by receiving the driver's braking intention as an electrical signal and activating devices such as motors.

This type of brake is called an Electro-Mechanical Brake (EMB), and such drum brakes are referred to as electro-mechanical drum brakes.

Typically, the electro-mechanical drum brake is equipped with a power transmission unit that converts the rotational motion of the motor into linear motion and then transfers it to a pressurization unit.

The traditional power transmission unit was primarily designed with a screw structure or a ball screw structure.

However, these power transmission units were designed to have a large stroke, considering the wear of the brake shoes, resulting in a limitation to the miniaturization of both the power transmission unit and the drum brake.

Additionally, the pair of brake shoes provided in the drum brake wear differently due to the direction of wheel rotation, with the leading shoe and trailing shoe experiencing different wear patterns.

However, the traditional power transmission unit applied the same stroke pressure towards the asymmetrically worn pair of brake shoes, which led to the brake shoes receiving an imbalanced force. Consequently, this resulted in a reduction in the braking stability of the drum brake.

Therefore, the present disclosure proposes a drum brake that can be miniaturized and can prevent the reduction of braking stability due to the wear of brake shoes.

### SUMMARY

It is an aspect of the disclosure to provide a miniaturized drum brake.

It is an aspect of the disclosure to provide a miniaturized drum brake with a power transmission unit that allows for a compact design.

It is an aspect of the disclosure to provide a drum brake with improved braking stability.

It is an aspect of the disclosure to provide a drum brake with improved braking stability by delivering a uniform force to a pair of brake shoes that wear differently.

It is an aspect of the disclosure to provide a drum brake with improved marketability by enabling miniaturization of the drum brake and improving braking stability.

Additional aspects of the disclosure will be set forth in part in the description which follows and, in part, will be obvious from the description, or may be learned by practice of the disclosure.

In accordance with one aspect of the present disclosure, a drum brake includes a motor configured to provide rotational driving force, a pair of pressurizing units configured to press a brake shoe into an inner circumferential surface of a drum and a power transmission unit configured to transmit rotational driving force of the motor to the pressurizing units, wherein the power transmission unit includes a shaft rotating with rotational driving force of the motor, a cam rotating in connection with the shaft, and a pair of rollers arranged on opposite sides of the cam for a translational movement with rotation of the cam and fixed respectively to the pair of pressurizing units, and wherein the shaft and the cam are connected by a universal joint such that a rotational axis of the shaft and a rotational axis of the cam form a certain angle.

The shaft may include a first yoke at an end of the cam side, the cam may include a second yoke at an end of the shaft side, and the universal joint may be connected by intersecting the first yoke and the second yoke with each other.

The power transmission unit may further include a spider disposed between the shaft and the cam and having a vertical member and a horizontal member, and the universal joint may be such that the vertical member is connected with the first yoke and the horizontal member is connected with the second yoke.

The first yoke may include a first yoke body portion having a first plane opposite the second yoke, and a pair of first yoke paddles provided on opposite sides of the first yoke body portion and projecting toward the second yoke side, the second yoke may include a second yoke body portion having a second plane opposite the first yoke, and a pair of second yoke paddles provided on opposite sides of the second yoke body portion and projecting toward the first yoke side, and the universal joint may be connected by intersecting the pair of first yoke paddles and the pair of second yoke paddles.

The universal joint may include a first space between the first plane and the first yoke paddles, a second space between the second plane and the second yoke paddles, and a third space between the first yoke paddles and the second yoke paddles.

The first yoke paddles may include a first engagement hole configured to be penetrated by the vertical member, and the second yoke paddles may include a second engagement hole configured to be penetrated by the horizontal member.

The power transmission unit may further include a fastening member disposed between the first yoke paddles and the second yoke paddles to accommodate the spider.

The fastening member may include a plurality of through-holes arranged to accommodate the spider within, with each end of the vertical member and the horizontal member projecting outward.

The power transmission unit may include a first gear configured to rotate coaxially with a rotational axis of the motor, and a second gear configured to engage the first gear and having a rotational axis in a direction parallel to the rotational axis of the motor.

A diameter of the second gear may be provided to be greater than a diameter of the first gear.

The first gear and the second gear may be arranged as helical gears.

The power transmission unit may include a sun gear configured to rotate coaxially with the second gear, a plurality of planetary gears having an outer circumferential surface engaging an outer circumferential surface of the sun gear, and a ring gear having an inner circumferential surface engaging the outer circumferential surface of the planetary gears and configured to rotate coaxially with the sun gear.

The cam may be provided with a S-shaped cross-section.

The power transmission unit may further include a pin penetrating a center of the roller, the pair of pressurizing units may include a pressurizing unit body having a third plane opposite each other, and a pair of pressurizing unit paddles arranged on opposite sides of the pressurizing unit body and formed to project inward, and the pressurizing unit paddles may include a pin-receiving hole formed to be penetrated by the pin.

The pin-receiving hole may be provided with an opened shape on one side.

The roller includes a bearing.

In accordance with another aspect of the present disclosure, a drum brake includes a motor configured to provide rotational driving force, a pair of pressurizing units configured to press a brake shoe into an inner circumferential surface of a drum, and a power transmission unit configured to transmit rotational driving force of the motor to the pressurizing units, wherein the power transmission unit includes a shaft rotating with rotational driving force of the motor, and a cam rotating in connection with the shaft, wherein the pair of pressurizing units are arranged adjacent to opposite sides of the cam for a translational movement with rotation of the cam, and wherein the shaft and the cam are connected by a universal joint such that a rotational axis of the shaft and a rotational axis of the cam form a certain angle.

The pair of pressurizing units may include a fourth plane arranged to be in contact with a lateral side of the cam.

A vertical length of the cam may be formed to be longer than a horizontal length of the cam.

The cam may be provided with a hexagonal cross-section.

One embodiment of the present disclosure provides a miniaturized drum brake.

One embodiment of the present disclosure provides a miniaturized drum brake with a power transmission unit that allows for a compact design.

One embodiment of the present disclosure provides a drum brake with improved braking stability.

One embodiment of the present disclosure provides a drum brake with improved braking stability by delivering a uniform force to a pair of brake shoes that wear differently.

One embodiment of the present disclosure provides a drum brake with improved marketability by enabling miniaturization of the drum brake and improving braking stability.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a perspective view illustrating a drum brake according to one embodiment of the present disclosure;

FIG. 2 is a perspective view illustrating a detailed configuration of a drum brake according to a first embodiment of the present disclosure in an assembled state;

FIG. 3 is a perspective view illustrating the detailed configuration of the drum brake according to the first embodiment of the present disclosure in a disassembled state;

FIG. 4 is an enlarged view illustrating a universal joint of a drum brake according to one embodiment of the present disclosure;

FIG. 5 is a perspective view illustrating a gear configuration of a drum brake according to one embodiment of the present disclosure in an assembled state;

FIG. 6 is a perspective view illustrating a detailed configuration of a drum brake according to a second embodiment of the present disclosure in an assembled state; and

FIG. 7 is a perspective view illustrating the detailed configuration of the drum brake according to the second embodiment of the present disclosure in a disassembled state.

### DETAILED DESCRIPTION

Hereinafter, embodiments of the present disclosure will be described in detail with reference to the accompanying drawings. The following embodiments are presented in order to sufficiently convey the ideas of the present disclosure to a person skilled in the art to which the present disclosure belongs. The present disclosure is not limited to the embodiments shown herein and may be embodied in other forms. To clarify the present disclosure, the drawings may omit portions that are not relevant to the description, and the sizes of components may be somewhat exaggerated for easy understanding.

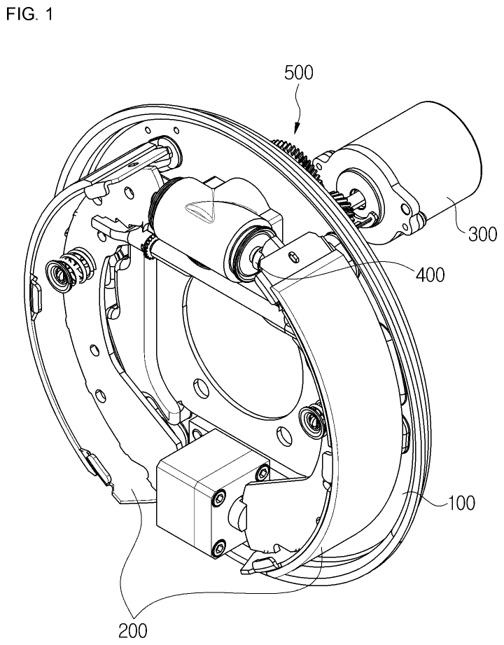

FIG. 1 is a perspective view illustrating a drum brake 10 according to one embodiment of the present disclosure.

Referring to FIG. 1, a drum brake 10 according to one embodiment of the present disclosure is an electro-mechanical brake and includes a drum (not shown), a backplate 100, brake shoes 200, a motor 300, a pressurizing unit 400, and a power transmission unit 500.

The drum is a cylindrical configuration that is attached to a wheel hub, and when a wheel rotates, the brake shoes 200 are pressed into the drum to reduce speed through friction. The drum is typically made of iron or cast iron, and has a friction surface on the inside that creates friction with the brake shoes 200.

The brake shoes 200 are located on the inside of the drum so that they can rub against the rotating drum. Generally, a pair of brake shoes 200 are provided, and when the driver depresses the brake pedal, the brake shoes 200 move into the inside of the drum and rub against the friction surface of the drum.

The brake shoes 200 include a leading shoe located at the front of the traveling direction and a trailing shoe located at the rear of the traveling direction.

The backplate 100 serves to support the brake shoes 200 and maintain a gap between the brake shoes 200 and the drum. The backplate 100 is primarily made of a metal material.

The motor 300 is electronically operated to provide rotational driving force in one direction or another. In one example, the motor 300 may be a brushless AC motor with high power output. However, the motor 300 of the present disclosure is not limited to any type of motor.

The pressurizing unit 400 is configured to press the pair of brake shoes 200 to an inner circumferential surface of the drum by translational movement. In one example, the pressurizing unit 400 may be provided in pairs, with each outer end connected to the leading shoe and the trailing shoe, and the pressurizing unit 400 may move outward and forward to contact the brake shoes 200 and the drum during braking. Conversely, during non-braking, the pressurizing unit 400 may move inward backward to separate the brake shoes 200 from the drum.

The power transmission unit 500 is configured to transmit rotational driving force of the motor 300 to the pressurizing unit 400. In this case, the power transmission unit 500 converts the rotational movement of the motor 300 into the translational movement and transmits the translational movement to the pressurizing unit 400. In other words, the pressurizing unit 400 moves backward through the power transmission unit 500.

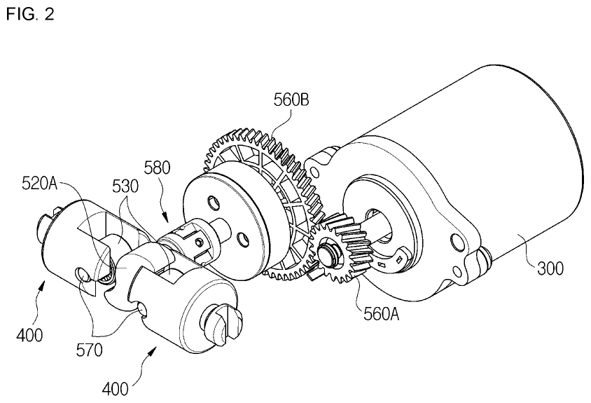

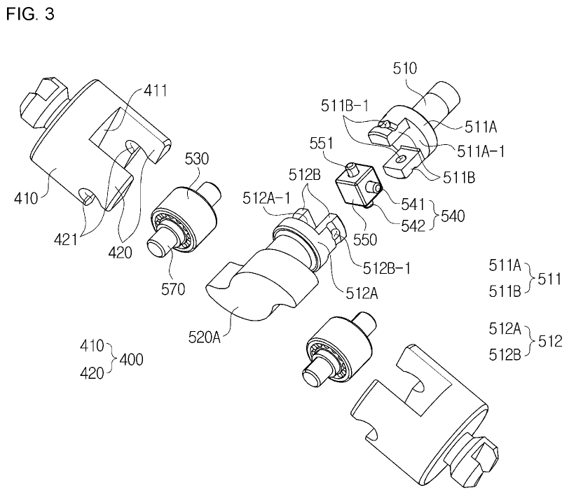

FIG. 2 is a perspective view illustrating a detailed configuration of a drum brake according to a first embodiment of the present disclosure in an assembled state. FIG. 3 is a perspective view illustrating the detailed configuration of the drum brake according to the first embodiment of the present disclosure in a disassembled state.

Referring to FIGS. 2 and 3, the drum brake 10 according to the first embodiment of the present disclosure includes the power transmission unit 500 arranged between the motor 300 and the pressurization unit 400, and the power transmission unit 500 includes a shaft 510 and a cam 520A connected by a plurality of gears 560A, 560B and a universal joint 580.

The plurality of gears 560A, 560B are configured to transmit rotational driving force to the motor 300, as will be described in more detail later.

The shaft 510 is rotated by rotational driving force from the motor 300. The cam 520A is connected to and rotates with the shaft 510. Specifically, shaft 510 is connected with a gear on one side to rotate coaxially with second gear 560B. The other side of the shaft 510 is connected by the universal joint 580 with one side of the cam 520A. Thus, the cam 520A can rotate about a rotational axis that forms a certain angle with a rotational axis of the shaft 510.

The pressurizing unit 400-side end of the cam 520A may have various shapes. The power transmission unit 500 according to the first embodiment of the present disclosure is provided with an S-shaped cross-section of the end of the cam 520A.

The pair of pressurizing units 400 include a pressurizing unit body 410 having a third plane 411 opposite each other, and a pair of pressurizing unit paddles 420 arranged on opposite sides of the pressurizing unit body 410 and formed to project inward.

Rollers 530 are provided in pairs and disposed on opposite sides of the cam 520A. The pair of rollers 530 are fixed to each of the pair of pressurized units 400. The rollers 530 may be provided as roller 530 bearings.

A pin 570 is arranged to penetrate a center of the roller 530. A pin receiving-hole 421 is penetratively formed for insertion of the pin 570 into the pressurizing unit paddles 420. Thus, the pin 570 may be secured to the pressurizing unit paddles 420 through the pin receiving-hole 421, and the roller 530 may be rotatably coupled to the pin 570. When the cam 520A is rotated, the pair of rollers 530 rotate about the pin 570 and move the pin 570 outward, and therefore, the pair of pressurizing units 400 move outward and forward.

The pin receiving-hole 421 may be provided with a closed shape, or may be provided with an opened shape on one side. It is advantageous if the pin receiving-hole 421 is provided with the opened shape on one side, so that the pin 570 and roller 530 can be easily assembled into the pressurizing unit 400.

In the drum brake 10, the pair of brake shoes 200 are subjected to different degrees of wear. Specifically, the leading shoe located in front of the travel direction of the vehicle wears faster than the trailing shoe located behind the travel direction of the vehicle. Therefore, when the pair of brake shoes 200 are worn due to repeated braking of the brakes and the pressurizing unit 400 presses the pair of brake shoes 200 with the same stroke, imbalances occur in the forces received by the leading shoe and the trailing shoe.

The power transmission unit 500 of the present disclosure addresses this problem through the universal joint 580. The universal joint is a coupling that connects two power transmission shafts whose relative positions are constantly changing. The cams 520A, 520B of the present disclosure allow their rotational axis to form an angle toward the leading shoe relative to the rotational axis of the shaft 510 via the universal joint 580, thereby eliminating the imbalance of forces received by the leading shoe and the trailing shoe.

The universal joint 580 includes two yokes and a spider 540 connecting the two yokes. According to one embodiment of the present disclosure, the shaft 510 includes a first yoke 511 and the cam 520A includes a second yoke 512. The power transmission unit 500 may include the spider 540 to connect the first yoke 511 and the second yoke 512, and may further include a fastening member 550 to secure the position of the spider 540.

The first yoke 511 is provided at the cam 520A-side end of the shaft 510. The first yoke 511 includes a first yoke body portion 511A having a first plane 511A-1 opposite the second yoke 512, and a pair of first yoke paddles 511B provided on opposite sides of the first yoke body portion 511A and projecting toward the second yoke 512.

The second yoke 512 is provided at the shaft 510-side end of the cam 520A. The second yoke 512 includes a second yoke body portion 512A having a second plane 512A-1 opposite the first yoke 511, and a pair of second yoke paddles 512B provided on opposite sides of the second yoke body portion 512A and projecting toward the first yoke 511.

Accordingly, the universal joint 580 according to one embodiment of the present disclosure is connected by intersecting the first yoke 511 and the second yoke 512 with each other, or in other words, by intersecting the pair of first yoke paddles 511B and the pair of second yoke paddles 512B with each other.

The spider 540 is arranged between the shaft 510 and the cam 520A. The spider 540 has a vertical member 542 and a horizontal member 541 forming a cross.

The first yoke paddles 511B include a first engagement hole 511B-1 formed to be penetrated by the vertical member 542. The second yoke paddles 512B include a second engagement hole 512B-1 formed to be penetrated by the horizontal member 541. Thus, the vertical member 542 is inserted into the first engagement hole 511B-1 to connect with the first yoke 511, and the horizontal member 541 is inserted into the second engagement hole 512B-1 to connect with the second yoke 512.

The fastening member 550 is disposed between the first yoke paddles 511B and the second yoke paddles 512B to accommodate the spider 540. The fastening member 550 accommodates the spider 540 within and includes a plurality of through-holes 551 such that each end of the vertical member 542 and horizontal member 541 projects outward.

The fastening member 550 may be provided smaller than the space between the first yoke paddles 511B and the second yoke paddles 512B. Thus, the fastening member 550 and the spider 540 housed in the fastening member 550 are not completely restricted in their movement and can move some between the first yoke paddles 511B and the second yoke paddles 512B.

The shape of the fastening member 550 may vary. According to the first embodiment of the present invention, the fastening member 550 is formed as a cube and has through-holes 551 on four sides opposite the first yoke paddles 511B and the second yoke paddles 512B. However, the shape of the fastening member 550 of the present disclosure is not limited to the cube, but includes any shape, including a spherical shape, that can accommodate the spider 540 in the space between the first yoke paddles 511B and the second yoke paddles 512B.

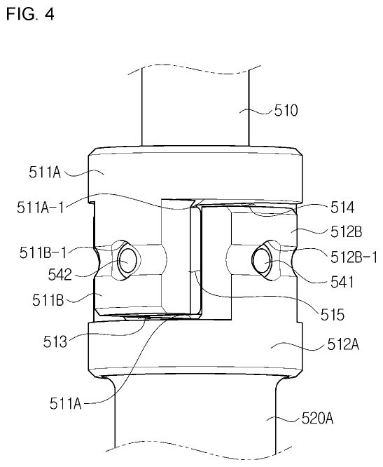

FIG. 4 is an enlarged view illustrating a universal joint of a drum brake according to one embodiment of the present disclosure.

Referring to FIG. 4, the drum brake 10 of one embodiment of the present disclosure includes a first space 513, a second space 514, and a third space 515 between the first yoke 511 and the second yoke 512.

The first space 513 may be provided between the first plane 511A-1 and the first yoke paddles 511B. The second space 514 may be provided between the second plane 512A-1 and the second yoke paddles 512B. The third space 515 may be provided between the first yoke paddles 511B and the second yoke paddles 512B. Thus, the cam 520A and the shaft 510 have a floating connection structure with the universal joint 580, and the second yoke 512 can be rotated a certain distance from the first yoke 511.

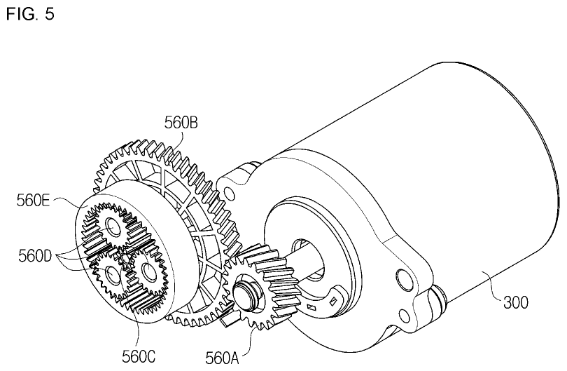

FIG. 5 is a perspective view illustrating a gear configuration of a drum brake according to one embodiment of the present disclosure in an assembled state.

Referring to FIG. 5, the drum brake 10 according to one embodiment of the present disclosure includes a first gear 560A and a second gear 560B that initially decelerate rotational driving force of the motor 300, and a sun gear 560C, a planetary gear 560D, and a ring gear 560E that subsequently decelerate rotational driving force.

The first gear 560A rotates coaxially with the rotational axis of the motor 300. The second gear 560B engages the first gear 560A and rotates about a rotational axis spaced apart from the rotational axis of the motor 300. A diameter of the second gear 560B is provided to be greater than a diameter of the first gear 560A. Accordingly, the second gear 560B acts as a reduction gear to reduce the rotational speed and amplify the torque.

The first gear 560A and the second gear 560B may be helical gears having beveled teeth that engage each other. Helical gears have the advantage of having a longer contact line between the teeth than conventional gears, which allows for transmission of greater forces and lower noise.

The sun gear 560C rotates coaxially with the second gear 560B. The planetary gear 560D is provided in a plurality such that its outer circumferential surface engages an outer circumferential surface of the sun gear 560C, and the ring gear 560E engages an inner circumferential surface of the planetary gear 560D but rotates coaxially with the sun gear 560C. Thus, the sun gear 560C, the planetary gear 560D, and the ring gear 560E act as reduction gears to reduce the rotational speed and increase the torque.

Therefore, the power transmission unit 500 according to one embodiment of the present disclosure has an efficient reduction structure by being able to reduce rotational driving force of the motor 300 in two stages through the plurality of gears 560A, 560B, 560C, 560D, and 560E, and additionally has a brushless alternating current motor with a high power output and the cam 520A structure, so that the power transmission unit 500 can be designed with higher power transmission efficiency and smaller size than the conventional power transmission unit 500. In other words, miniaturization of the power transmission unit 500 and the drum brake 10 is possible. Hereinafter, the drum brake 10 according to the second embodiment of the present invention will be described.

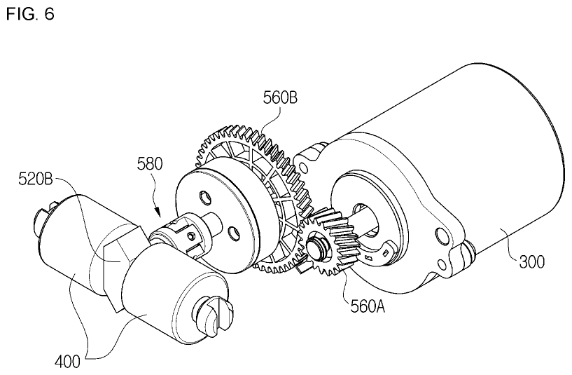

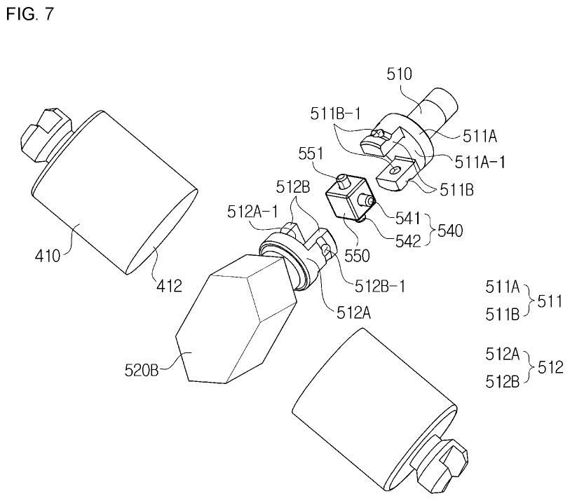

FIG. 6 is a perspective view illustrating a detailed configuration of a drum brake according to a second embodiment of the present disclosure in an assembled state. FIG. 7 is a perspective view illustrating the detailed configuration of the drum brake according to the second embodiment of the present disclosure in a disassembled state.

Referring to FIGS. 6 and 7, the drum brake 10 according to the second embodiment of the present disclosure transmits power by the cam 520B contacting the pair of pressurizing units 400.

The description of the drum brake 10 according to the second embodiment of the present disclosure is the same as the description of the drum brake 10 according to the first embodiment described above, except where further described by separate numerals. In the following, the description of the drum brake 10 according to the second embodiment that is identical to the first embodiment is omitted to avoid redundant description.

The pair of pressurizing units 400 are arranged adjacent to opposite sides of the cam 520B, but are arranged to be in direct contact with the rotating cam 520B. Specifically, the pair of pressurizing units 400 have a fourth plane 412 on an inside, and the fourth plane 412 contacts a lateral surface of the rotating cam 520B. Thus, as the cam 520B rotates, opposite sides of the cam 520B push the fourth plane 412 outward, and as a result, the pair of pressurizing units 400 move outward and forward.

The cam 520B is formed such that a vertical length is longer than a horizontal length. Specifically, the cam 520B according to the second embodiment of the present disclosure is provided with a hexagonal cross-section, but the vertical length is longer than the horizontal length. However, the shape of the cam 520B of the present disclosure is not limited to the hexagonal shape, but includes any shape capable of converting rotational movement into translational movement.

In this manner, the drum brake 10 according to one embodiment of the present disclosure can be designed with high power transmission efficiency and compactness by including the power transmission unit 500 as a leased alternating current motor, a two-stage reduction gear structure, and the like, and can increase braking stability by including the cam 520A, 520B structure to increase release efficiency and reduce residual drag in the event of an electro-mechanical brake failure such as a power cuts of the motor 300. In addition, the connection of the cams 520A, 520B and the shaft 510 is provided with the universal joint 580, which can transmit a uniform force to the pair of brake shoes 200 that wear asymmetrically, thereby improving braking stability. By enabling miniaturization of the drum brake 10 and improving braking stability, the marketability of the drum brake 10 and the vehicle is improved.

Although the present disclosure has been described by means of limited embodiments and figures, the present disclosure is not limited thereby, and various modifications and variations can be made by a person skilled in the art to which the present disclosure belongs, within the equitable scope of the technical idea of the present disclosure and the claims of the patent which will be described below.

What is claimed is:

1. A drum brake comprising:
a motor configured to generate rotational driving force;
a pair of presses configured to press a brake shoe toward an inner circumferential surface of a drum; and
a power transmission unit configured to transmit the rotational driving force of the motor to the presses,
wherein:
the power transmission unit includes a shaft configured to be rotatable by the rotational driving force of the motor, and a cam configured to be rotatable in association with rotation of the shaft,
the drum brake further comprises a pair of rollers rotatably fixed to the pair of presses, respectively, and rotatably contacting the cam to convert rotary movement of the cam into a translational movement, and
the shaft and the cam are operably connected by a universal joint such that a rotational axis of the shaft and a rotational axis of the cam are angled from each other.

2. The drum brake of claim 1, wherein:
the shaft includes a first yoke at an end of the shaft facing the cam,
the cam includes a second yoke at an end of the cam facing the shaft, and
the first yoke of the shaft and the second yoke of the cam are arranged to intersect each other to form the universal joint.

3. The drum brake of claim 2, wherein:
the power transmission unit further includes a spider disposed between the shaft and the cam and having a vertical member and a horizontal member, and
the vertical member of the universal joint is connected with the first yoke of the shaft and the horizontal member of the universal joint is connected with the second yoke of the cam.

4. The drum brake of claim 3, wherein:
the first yoke of the shaft includes a first yoke body portion having a first plane facing the second yoke of the cam, and a pair of first yoke paddles projecting from the first yoke body portion toward the second yoke of the cam,
the second yoke of the cam includes a second yoke body portion having a second plane facing the first yoke of the shaft, and a pair of second yoke paddles projecting from the second yoke body portion toward the first yoke of the shaft, and
the pair of first yoke paddles and the pair of second yoke paddles are arranged to intersect each other.

5. The drum brake of claim 4, wherein the universal joint has a first space provided between the second plane of the second yoke and one of the first yoke paddles, a second space provided between the first plane of the first yoke and one of the second yoke paddles, and a third space provided between the first yoke paddles and the second yoke paddles.

6. The drum brake of claim 4, wherein:
each of the first yoke paddles includes a first engagement hole in which the vertical member of the universal joint is inserted, and
each of the second yoke paddles includes a second engagement hole in which the horizontal member of the universal joint is inserted.

7. The drum brake of claim 3, wherein the power transmission unit further includes a fastening member accommodating a part of the spider therein and disposed between the first yoke paddles and the second yoke paddles.

8. The drum brake of claim 7, wherein the fastening member includes a plurality of through-holes such that the part of the spider disposed in the fastening member and ends of the vertical member and the horizontal member of the spider project outward through the through-holes.

9. The drum brake of claim 1, wherein the power transmission unit includes a first gear configured to be rotatable coaxially with a rotational axis of the motor, and a second gear rotatably engaged with the first gear and having a rotational axis parallel to the rotational axis of the motor.

10. The drum brake of claim 9, wherein a diameter of the second gear is greater than a diameter of the first gear.

11. The drum brake of claim 9, wherein the first gear and the second gear are helical gears.

12. The drum brake of claim 9, wherein the power transmission unit further includes:
a sun gear configured to be rotatable coaxially with the second gear,
a plurality of planetary gears rotatably engaging an outer circumferential surface of the sun gear, and
a ring gear having an inner circumferential surface rotatably engaging the planetary gears and configured to be rotatable coaxially with the sun gear.

13. The drum brake of claim 1, wherein the cam has a substantially S-shaped cross-section.

14. The drum brake of claim 1, wherein:
the power transmission unit further includes a pin coupled to the roller,
each of the pair of presses includes a pressurizing unit body having a third plane, and pressurizing unit paddles protruding from the pressurizing unit body toward the cam, and
each of the pressurizing unit paddles includes a hole or recess in which the pin is inserted.

15. The drum brake of claim 14, wherein an opening is formed at a side of the hole of at least one of the pressurizing unit paddles.

16. The drum brake of claim 1, wherein the roller includes a bearing.

17. A drum brake comprising:
a motor configured to generate rotational driving force;
a pair of presses configured to press a brake shoe toward an inner circumferential surface of a drum; and
a power transmission unit configured to transmit the rotational driving force of the motor to the presses,
wherein:
the power transmission unit includes a shaft configured to be rotatable by the rotational driving force of the motor, and a cam configured to be rotatable in association with rotation of the shaft,
the pair of presses are configured to be translatable in association with rotary movement of the cam and contacting the cam to convert the rotary movement of the cam into a translational movement of the presses, and
the shaft and the cam are connected by a universal joint such that a rotational axis of the shaft and a rotational axis of the cam are angled from each other.

18. The drum brake of claim 17, wherein each of the pair of presses includes a plane arranged to be in contact with a lateral side of the cam.

19. The drum brake of claim 17, wherein a vertical length of the cam is longer than a horizontal length of the cam.

20. The drum brake of claim 19, wherein the cam has a substantially hexagonal cross-section.
